(19) United States
(12) Patent Application Publication
(10) Pub. No.: US 2003/0115099 A1
(43) Pub. Date: Jun. 19, 2003

(54) Method of automated online media planning and buying

(76) Inventors: Stanley S. Burns JR., Thousand Oak, CA (US); Gary Guseinov, Santa Monica, CA (US)

Correspondence Address: Barley, Snyder, Senft & Cohen, LLC, 126 East King Street, Lancaster, PA, 17602-2893, US

(21) Appl. No.: 10/262,125

(22) Filed: Oct. 1, 2002

Related U.S. Application Data
(60) Provisional application No. 60/335,603, filed on Nov. 1, 2001.

(51) Int. Cl. G06F 17/60

(52) U.S. Cl. 705/14

(57) ABSTRACT

The invention is directed to be a primary marketing tool that automates many of the efforts required to select and place media for an on-line campaign. The marketing tool provides a communications link with the top 500 Tier 1 Web sites, the top 100 e-mail providers, and the top 50 Internet and ad networks. Together this enables the user to reach over 80% of all commercially available media providers. The database provides contact, demographic, and standard pricing information, as well as electronic Request for Pricing e-mail capabilities. A user of the database can research, design, select, and issue pricing requests to specifically qualified sites in a tenth of the time it previously took to develop a campaign. This enables users to leverage up their staff to larger and more numerous people.

### FIELD OF THE INVENTION

The invention relates to a method of automated online media planning and buying. In particular, the invention is related to automated online media planning, RFP distribution, contract negotiation, media buying and media optimization.

### BACKGROUND OF THE INVENTION

Despite the recent changes in the Internet business world, Internet and on-line marketing expenditures continue to grow, with a changing focus to meet the demands of the client for measurable results and clear proof of revenue generation. The simple banner ads approach of the past is rapidly being replaced with sophisticated, targeted campaigns that take full advantage of the Internet's unique media and sales tracking capabilities. Consequently, advertising agencies, direct marketing firms, and clients are searching for better tools to improve online media planning, buying, and campaign management. The current process is a laborious, resource intensive business requiring extensive phone, fax, and e-mail communications. There are no clear standards for purchasing online media and yet marketers are demanding “performance based” solutions that deliver immediate and direct return on advertising investment.

As a result, companies have been frustrated with results from their early Internet advertising, receiving a large number of “impressions” or “clicks” but few resulting sales. This was further compounded by the difficulty in efficiently coordinating the separate ad content developers, media providers, and campaign tracking/measurement vendors to execute the total program. Lastly, there was little previous marketing data available with which to compare results and modify the campaign if sales were not being attained. In many cases, Internet marketing, despite all its features and potential, was not bringing in the revenues. New tools are needed for automating the online media planning and buying process.

### SUMMARY OF THE INVENTION

In order to provide a more productive media planning and buying process, a proprietary technology system and process has been developed to decrease planning and buying costs, increase staff productivity, achieve high customer satisfaction, increase returns on marketing investment for its clients, and provide a robust database of marketing information key to making campaign decisions.

The invention is directed to be a primary marketing tool that automates many of the efforts required to select and place media for an on-line campaign. The marketing tool provides a communications link with the top 500 Tier 1 Web sites, the top 100 e-mail providers, and the top 50 Internet and ad networks. Together this enables the user to reach over 80% of all commercially available media providers. The database provides contact, demographic, and standard pricing information, as well as electronic Request for Pricing e-mail capabilities. A user of the database can research, design, select, and issue pricing requests to specifically qualified sites in a tenth of the time it previously took to develop a campaign. This enables users to leverage up their staff to larger and more numerous people.

The invention is an online media planning and buying tool that allows agencies to:

dramatically streamline the online media planning and buying process;

target “active buyers” currently navigating the web for advertisers' product/service;

access high volume “performance-based” media providers; and

automate the online media buying process.

### BRIEF DESCRIPTION OF THE DRAWINGS

FIG. 1 illustrates an overview of the method of media planning according to the present invention.

FIG. 2 illustrates an exemplary content of a screen provided in an RFP creation process, showing an example of a campaign description.

FIG. 3 illustrates an exemplary content of a screen provided in the RFP creation process, showing the type of information available and the functions that can be performed with respect to the information.

FIG. 4 illustrates an exemplary content of a screen provided in the RFP creation process, showing examples of accepted offers.

FIG. 5 illustrates an exemplary content of a screen showing the searching options available.

FIG. 6 illustrates an exemplary content of a screen showing representative search results.

FIG. 7 illustrates an exemplary content of a screen provided in the RFP creation prior to the sending of the RFP.

FIG. 8 illustrates an exemplary content of a screen that is automatically generated and sent to a potential media provider.

FIG. 9 illustrates an exemplary content of a screen that is accessed by the media provider in order to respond to the RFP.

FIG. 10 illustrates an exemplary content of a screen provided in the customer profile option of the system.

FIG. 11 illustrates an exemplary content of a screen provided in the media analysis option of the system.

FIG. 12 illustrates an exemplary content of a screen provided in the reporting option of the system

FIG. 13 illustrates an exemplary content of a screen provided in the reporting option of the system, showing various fields in a database.

### DETAILED DESCRIPTION OF THE INVENTION

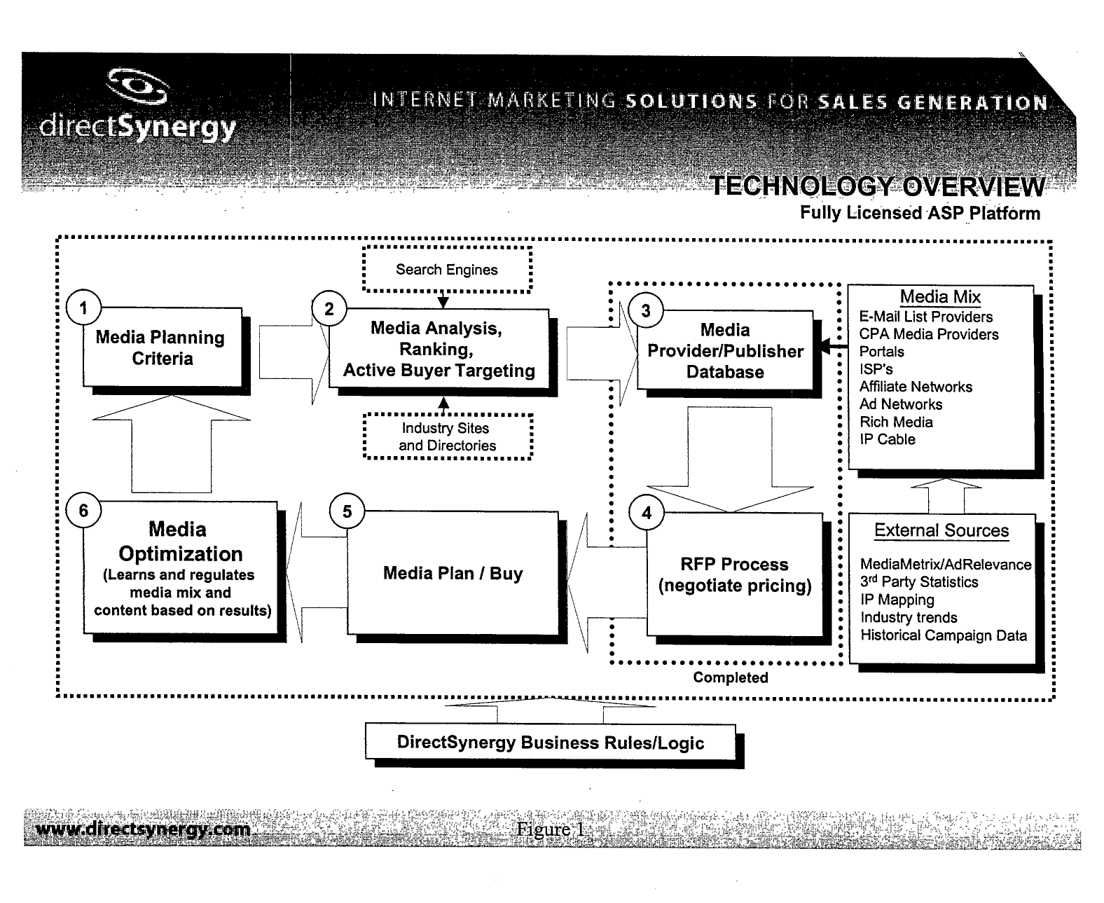

Referring to FIG. 1, the marketing system or method of this invention automates and optimizes many of the efforts required to select and place media for an on-line campaign. As represented in box 1, the media planning criteria is developed. Utilizing search engines and industry sites and directories, media analysis, ranking and active buyer targeting is accomplished, as shown in box 2. The system provides a communications link with many third party media providers to enable the user to reach a majority of the commercially available media providers. Referring to box 3, the system database provides many capabilities, including; contact information, demographic information, standard pricing, and electronic request for pricing (RFP) email procedures. This system allows the Internet media to be tracked for all providers. This allows the user to have much greater access than is currently available, i.e. where the user is limited to just the inventory of one provider. In addition to efficient media placement, the users competitors' on-line programs are analyzed to identify opportunities to outmaneuver them on the Web. It is important to note that media purchases are planned based on previous performance which are tracked in the database, and changed as the campaign progresses if they fail to perform. Referring to box 4, appropriate RFPs are automatically generated and sent. These RFPs are generated based on the information accumulated in the database. Responses to the RFPs are captured and analyzed to determine the best terms and pricing. As the database keeper works with many users, the database keeper can buy media in bulk for all its customers, thereby allowing the pricing to often be better than what could be attained by an individual company placing its own media. The appropriate media plan is then implemented as represented in boxes 5 and 6. The information learned is then reused to help formulate the media planning criteria for subsequent campaigns.

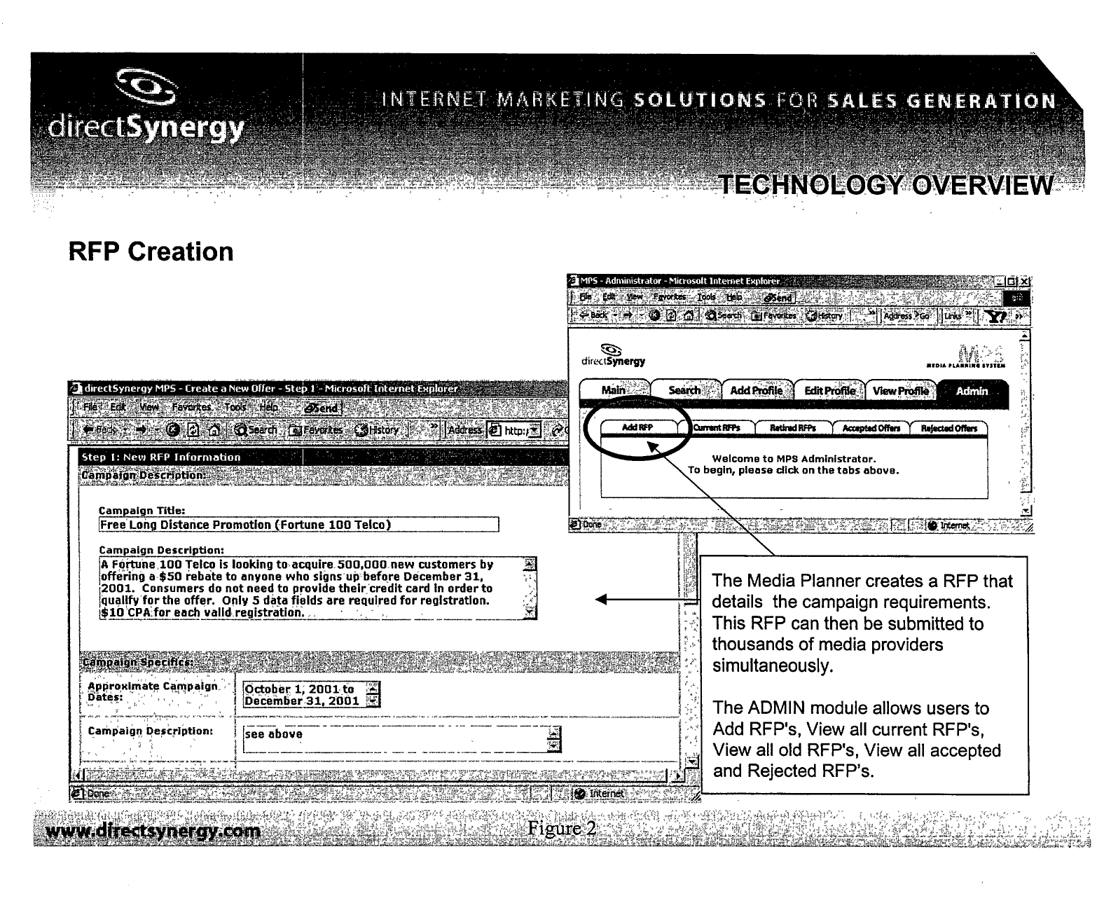

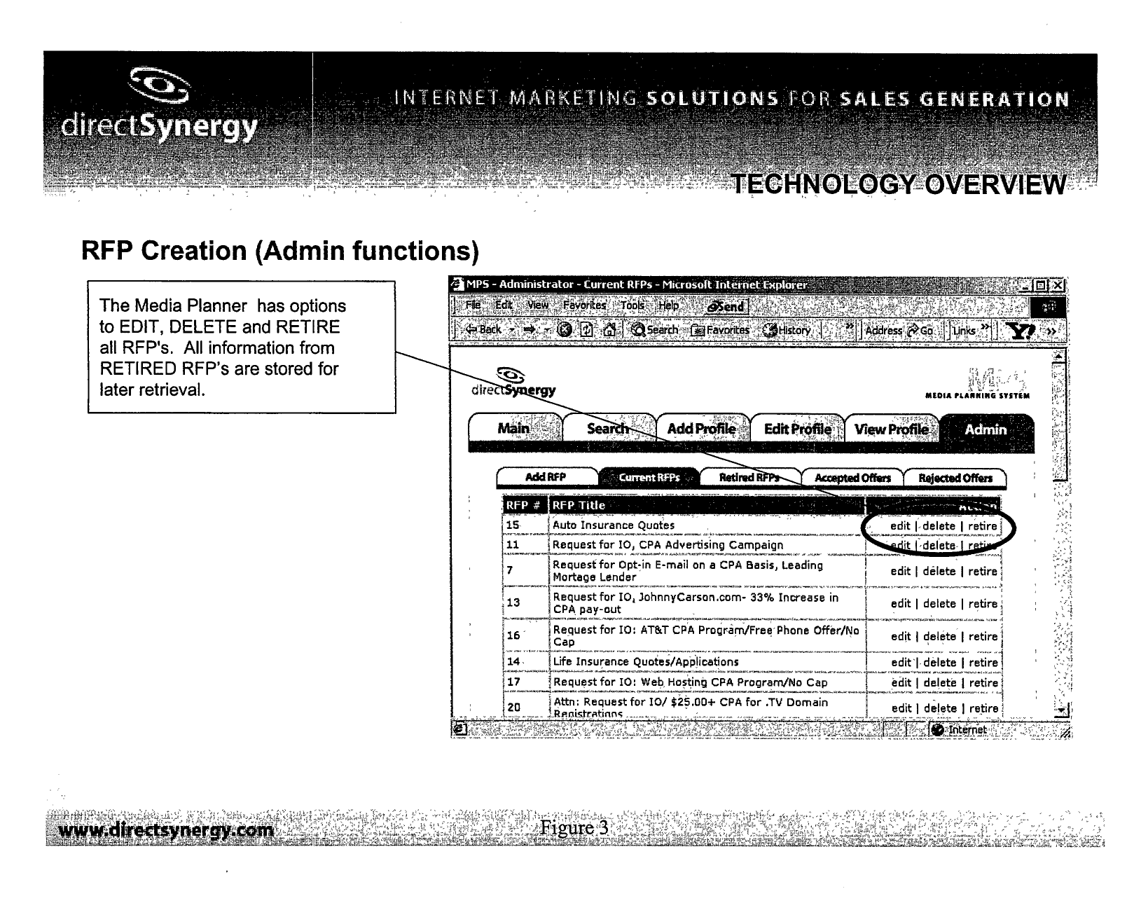

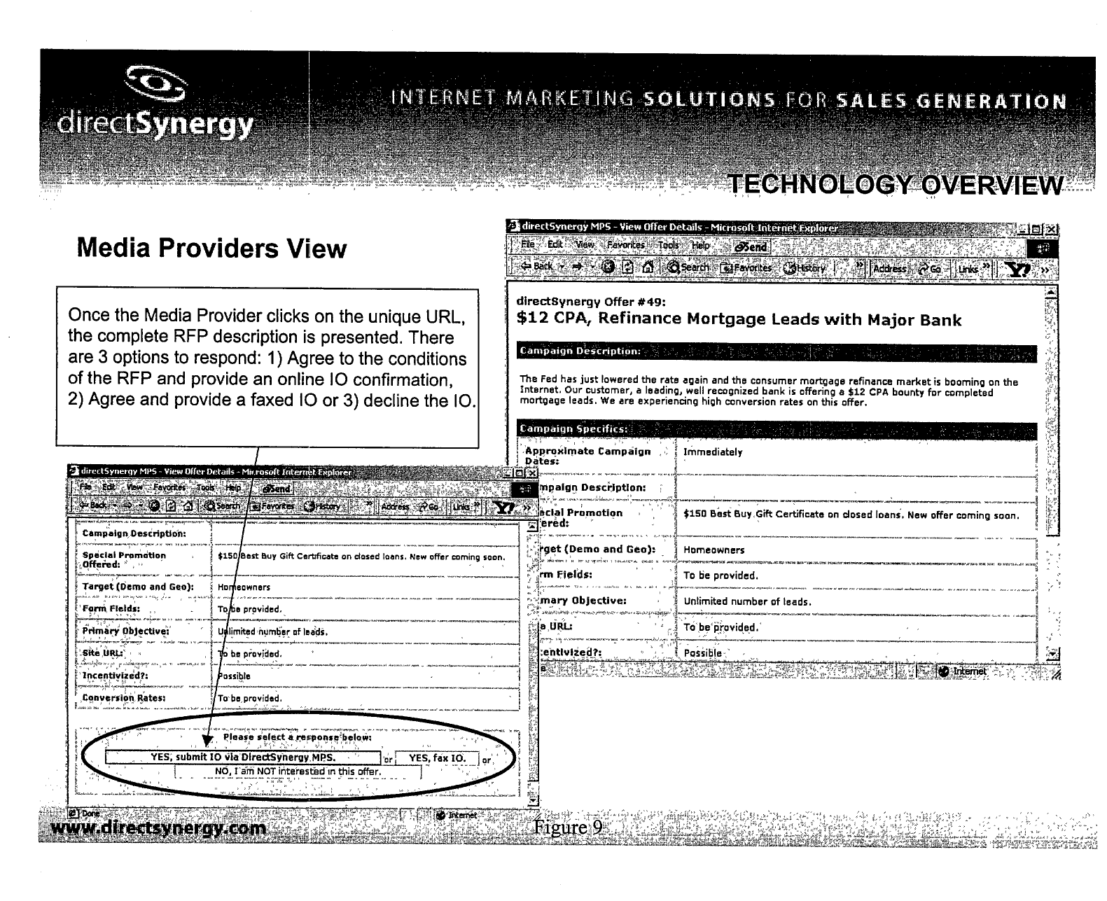

With reference to FIGS. 2 through 9, the system will be described in more detail, particularly with respect to boxes 3 and 4 of FIG. 1. As is shown in FIG. 2, a RFP is created that includes campaign targeting information, campaign goals, timelines, and other specific data for a customer online marketing program. The RFP can be submitted to many media providers simultaneously. As shown in the figure, the user can view all current RFPs, view all old RFPs, add RFPs, view all accepted or rejected RFPs, etc. In addition, the user can edit, delete or retire all RFPs as shown in FIG. 3. Information from retired RFPs can be retrieved if desired.

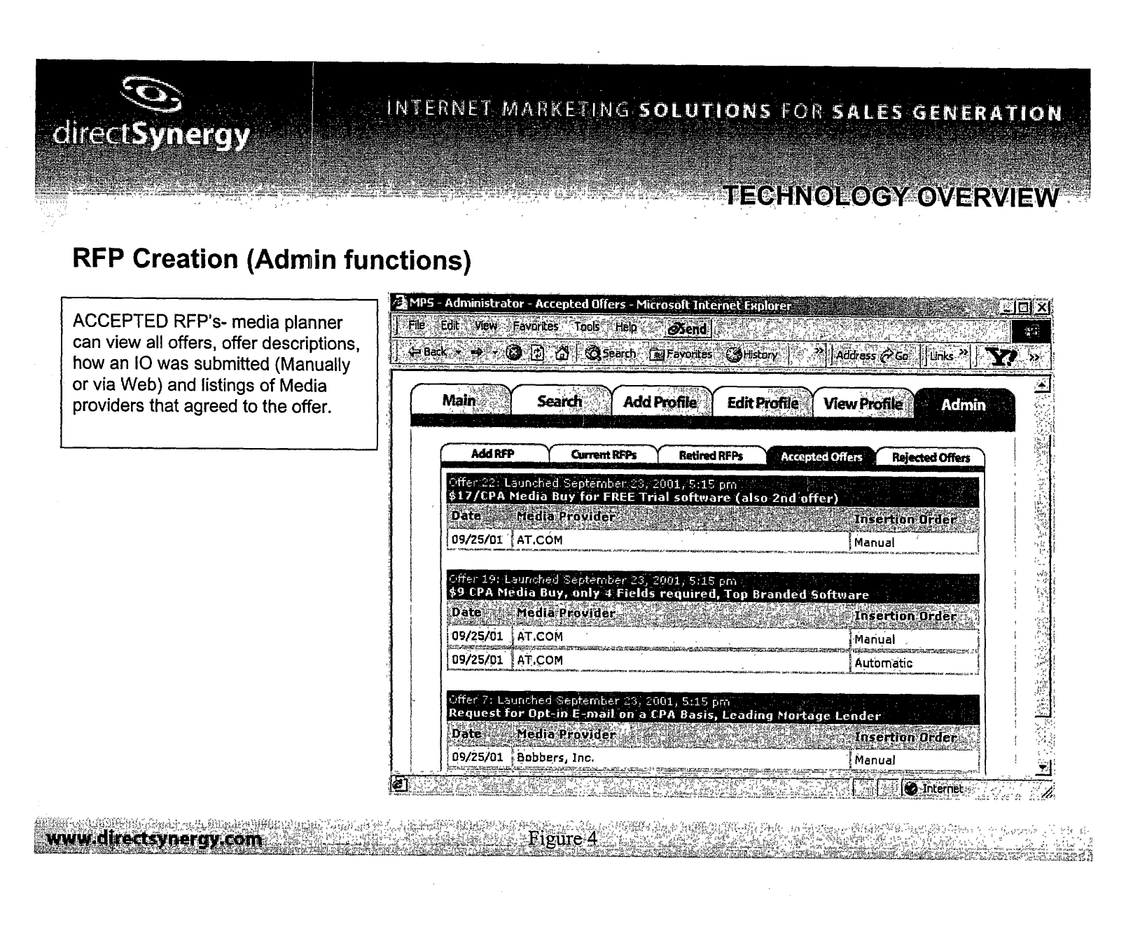

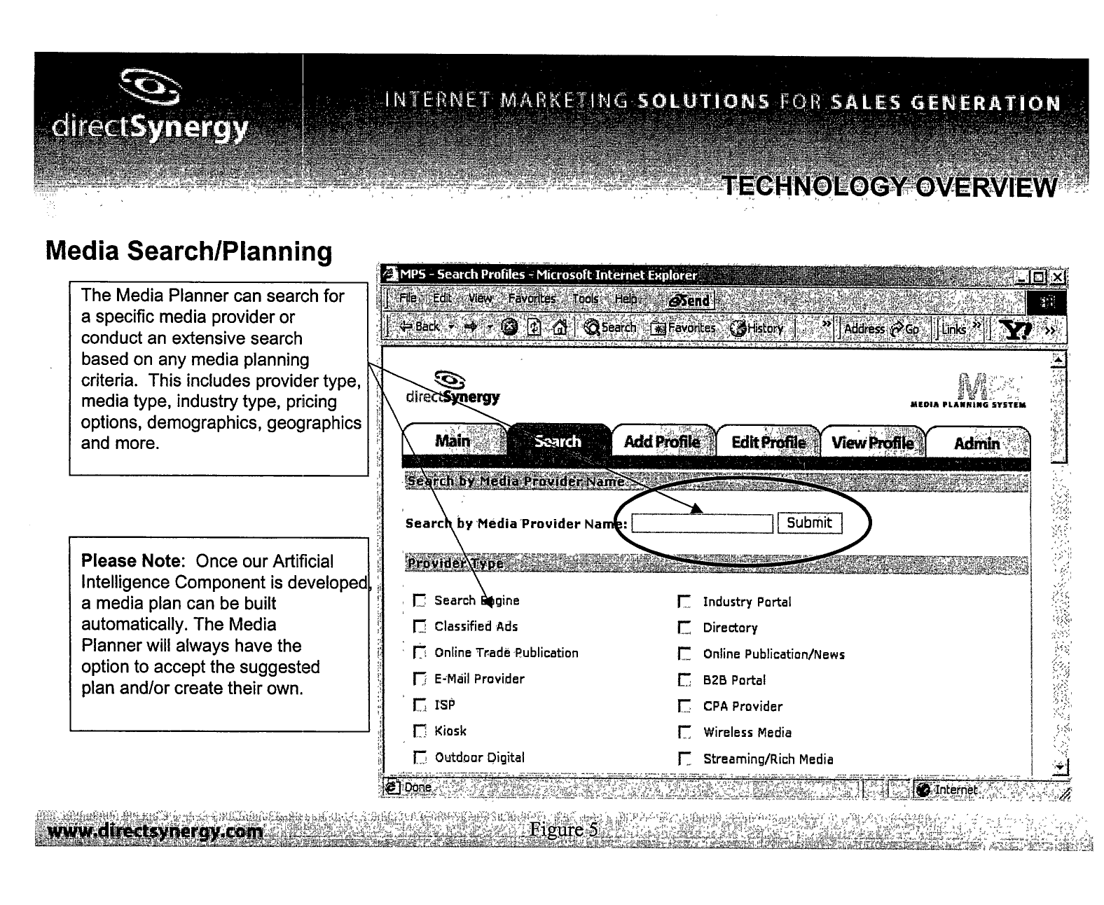

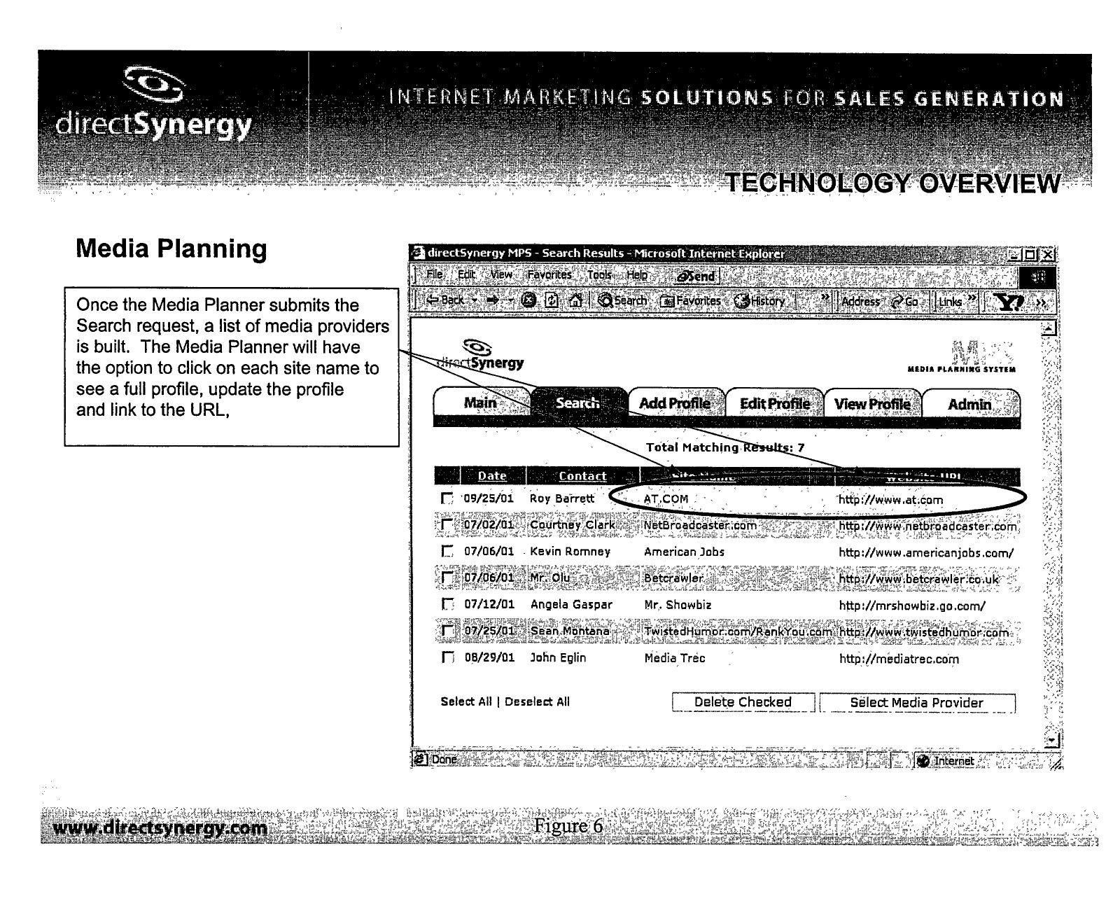

The database is searched by submitting media provider targeting data that includes provider type, media type, industry type, pricing options, demographic, geographic, and other criteria (FIG. 4). Providers are matched or selected and an appropriate list of media providers is built, as shown in FIG. 5. The user has the option to click on each site name to see a full profile of the provider. Referring to FIG. 6, an appropriate RFP is selected and the system automatically launches the RFP to all the media provider contacts via e-mail.

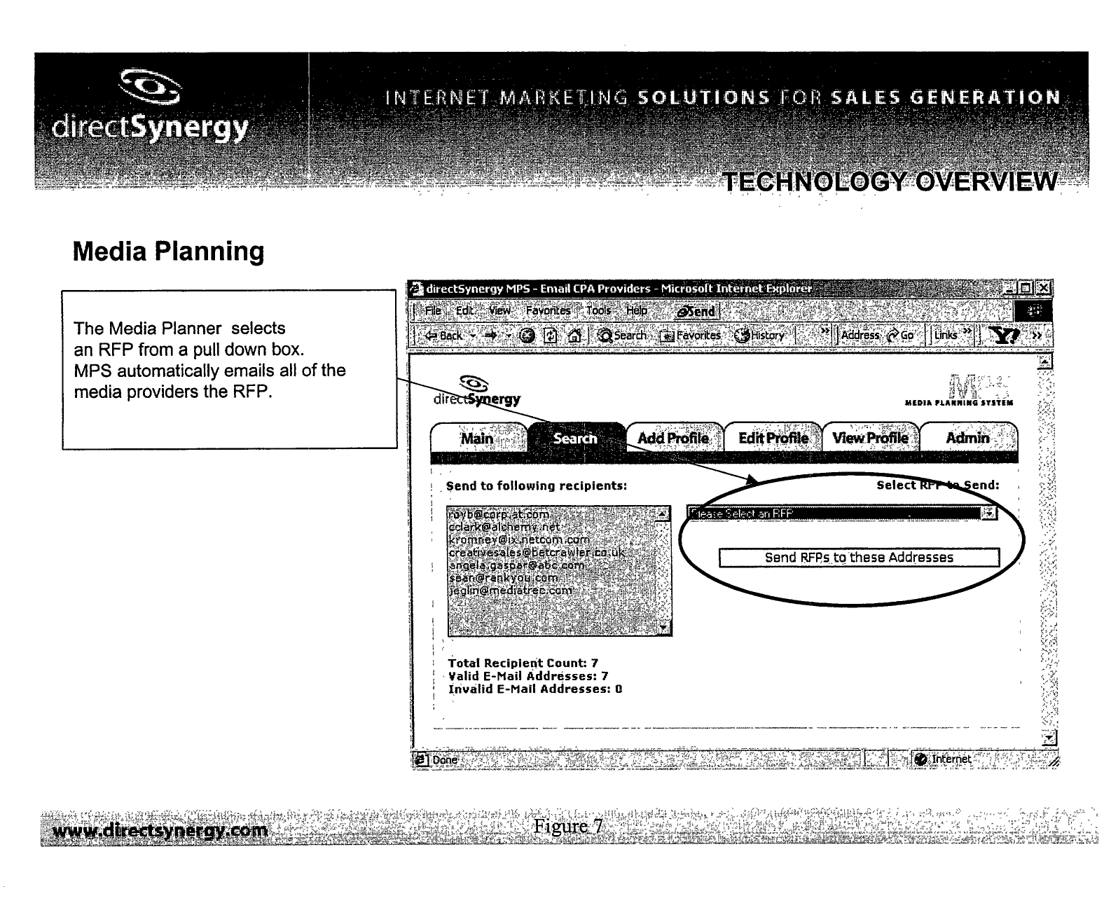

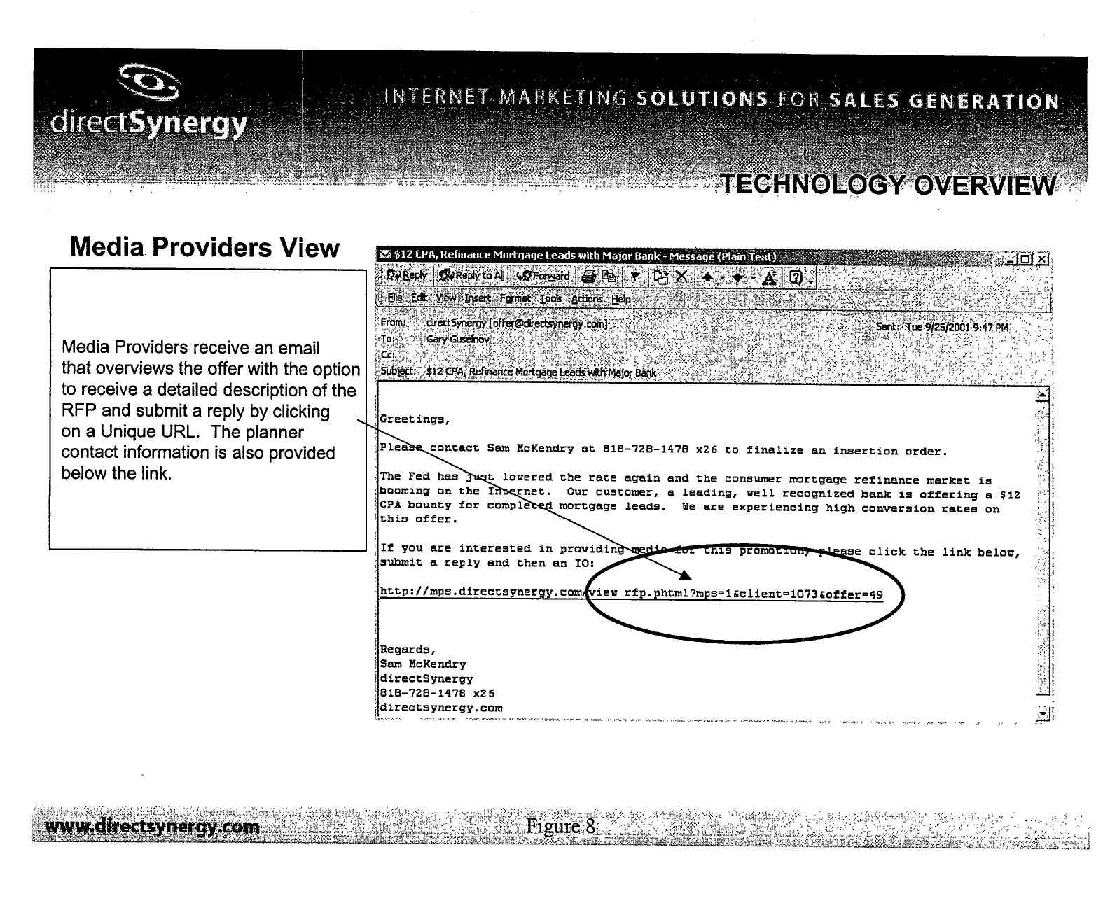

The providers receive the email the overviews the offer with the option to receive a detailed description of the RFP. The provider can submit a response using a unique URL provided in the email. This is represented in FIG. 7. If the provider clicks on the URL, the complete RFP description is provided (FIG. 8). Additionally the provider is presented with three options, which include: agree to the conditions of the RFP and provide an online insertion order, agree to the conditions of the RFP and provide a faxed insertion order, or decline. All orders are reviewed and the appropriate provider or providers are selected and the campaign is launched. The selection of the provider can be based on varying criteria, with pricing being one such criterion.

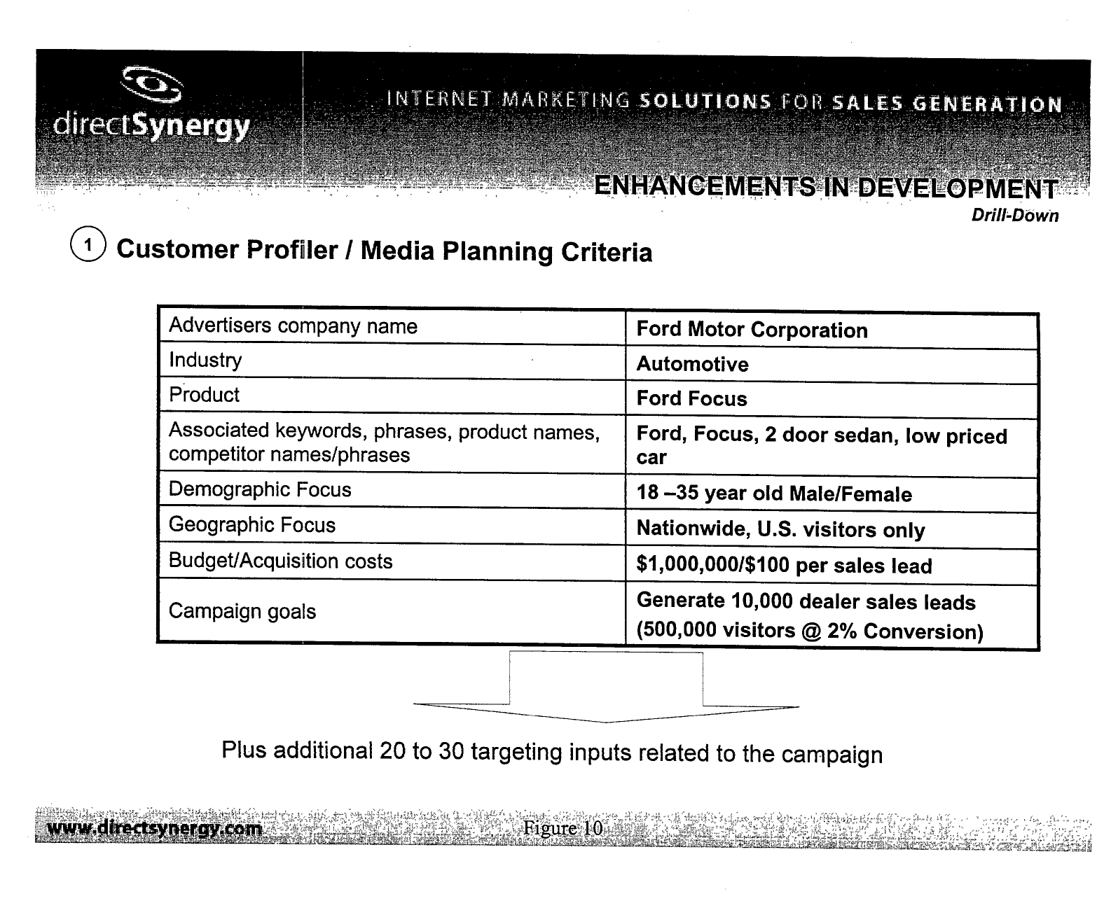

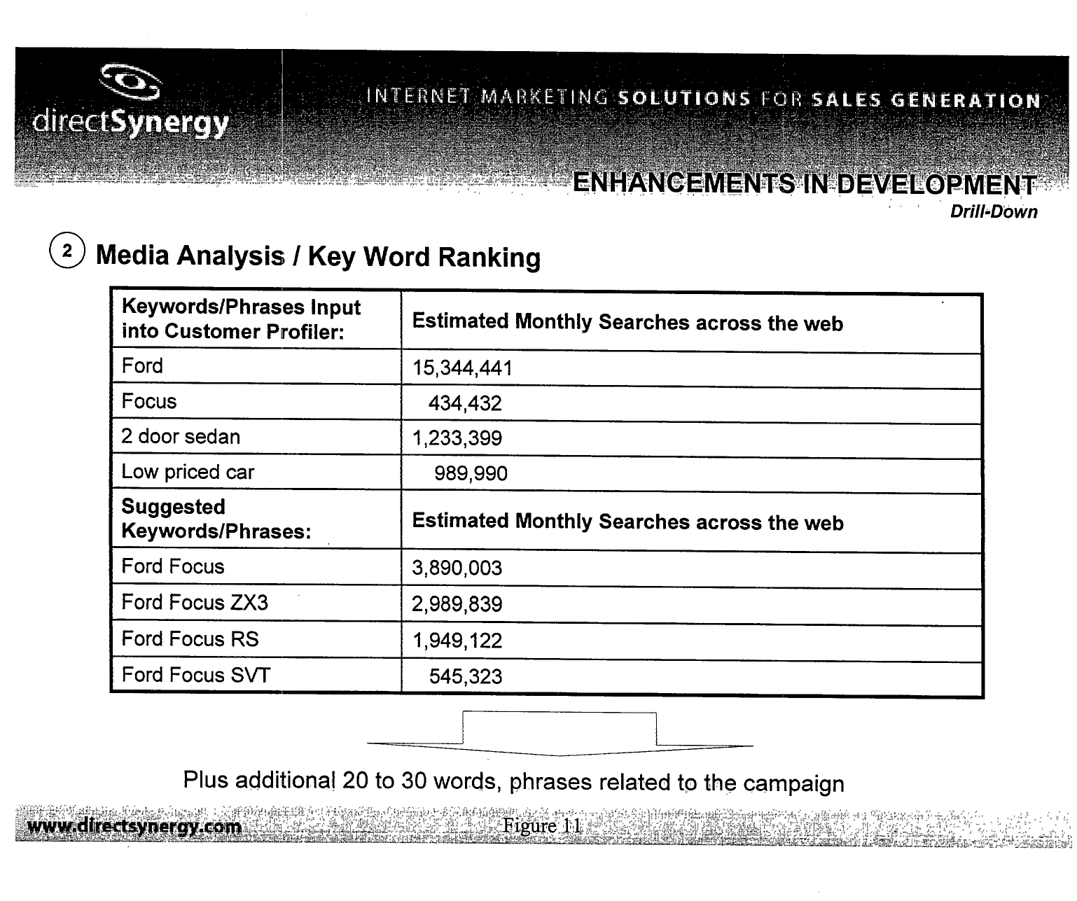

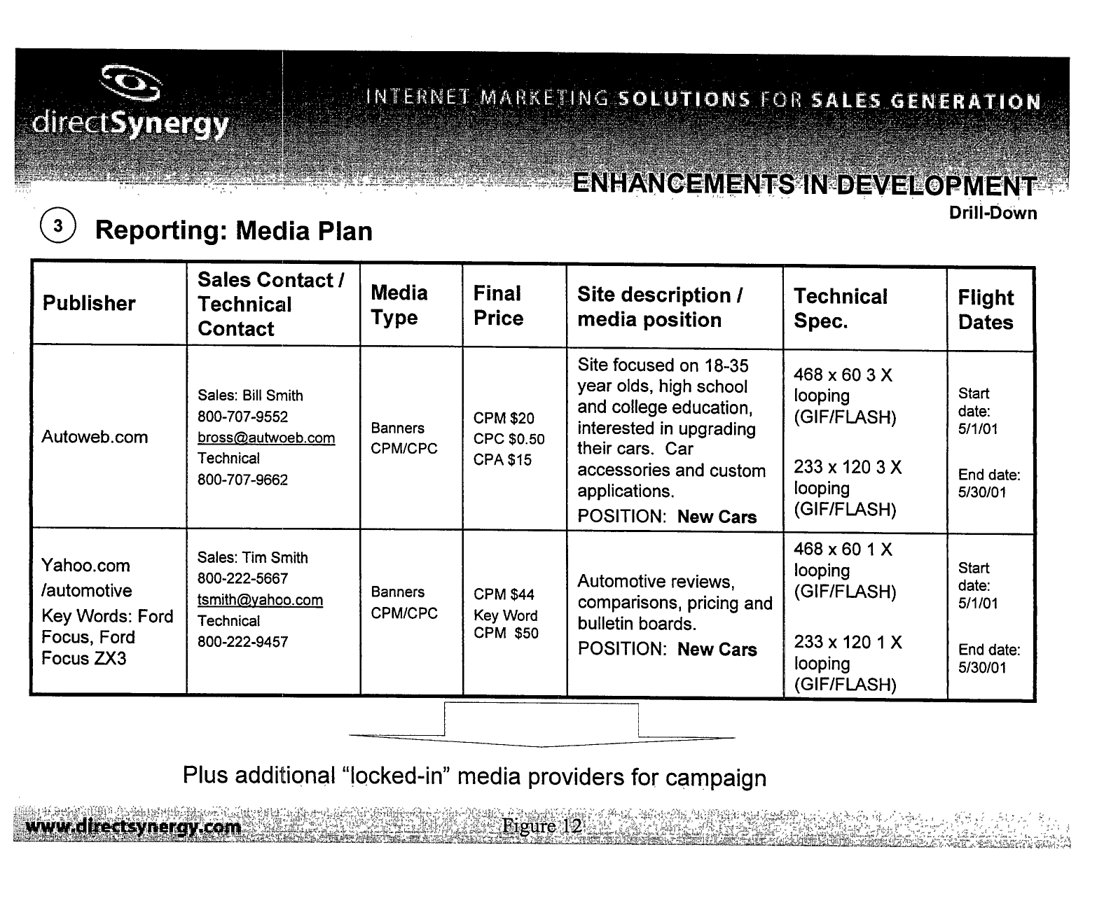

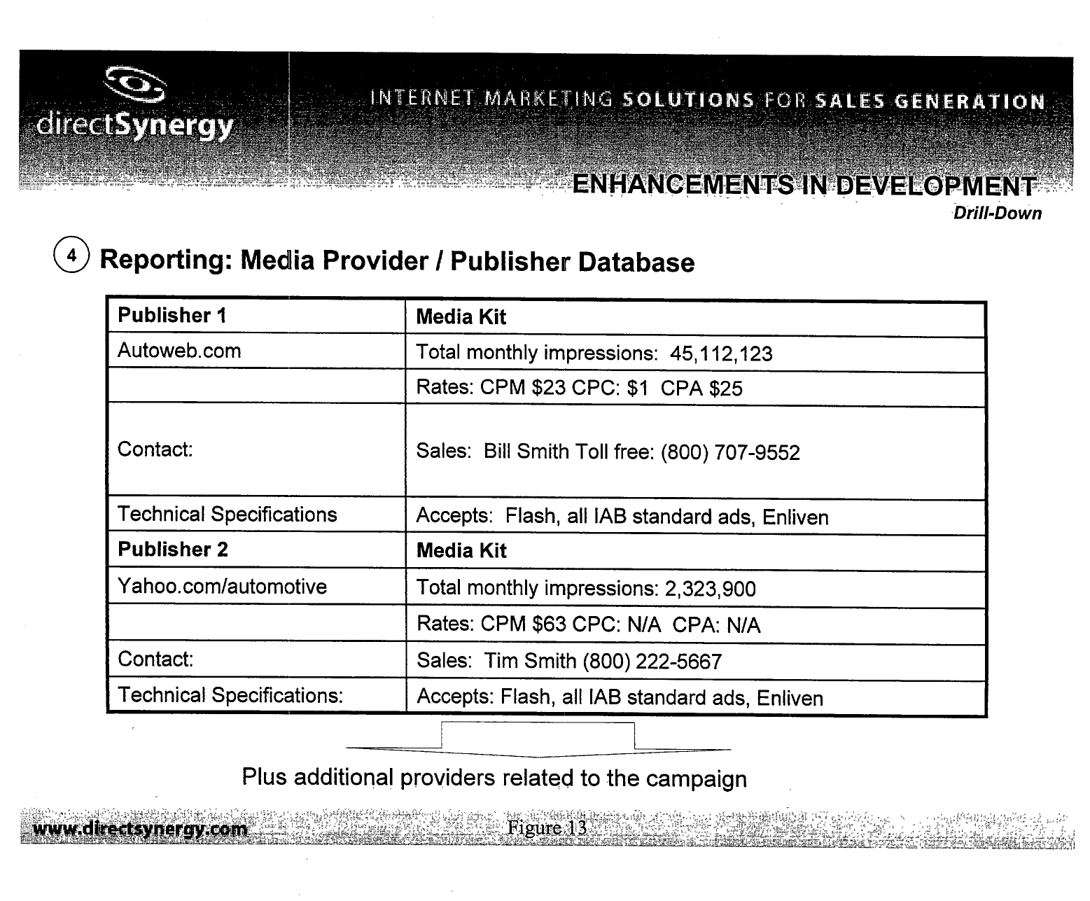

Other options for the system of the present invention are shown in FIGS. 10 through 13. FIG. 10 shows a representative customer profile with can be constructed and utilized to enhance the systems capabilities for niche markets. FIG. 11 depicts a media analysis/key work ranking module. This module will monitor search engine key-word navigation patterns, natural language analysis, web publisher context and competitor links to identify keyword placement and targeted Web site placement. The system automatically feeds this data into the database. This module uses artificial intelligence as its core technology. The reporting/media planner shown in FIG. 12 aggregates, analyzes and organized data and delivers a customized online medial plan and recommended online mix. The reporting/media provider database represented in FIG. 13, provides detailed media provider profile information that includes various fields of information.

This system or method provides many benefits to the user. These benefits include:

Automated media planning, buying, and IO processes.

Performance-based media options.

Targets “active Buyers” searching the web

Large scale RFP process expands media buy opportunities.

Open architecture provides connectivity to third-party systems.

Online media planning and buying becomes a profitable business for the agency.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A method of automating online media planning and buying and optimizing media effectiveness, comprising the steps of:
developing appropriate parameters of a media campaign for a customer;
comparing the parameters with a database to determine providers that can meet the parameters;
automatically generating request for pricing and sending the request for pricing to the providers;
reviewing and selecting at least one respective provider to proceed with the campaign.

2. The method as recited in claim 1 wherein the request for pricing is sent by email.

3. The method as recited in claim 1 wherein a customer profile is created.

4. The method as recited in claim 1 wherein the activity of third parties is electronically monitored to determine the effectiveness of the third parties media placement.

5. The method as recited in claim 4 wherein artificial intelligence is used to electronically monitor.

6. The method as recited in claim 4 wherein the information gathered is utilized to develop a customized media plan and recommended media mix for the customer.
